(19) United States
(12) Patent Application Publication
(10) Pub. No.: US 2008/0257563 A1
(43) Pub. Date: Oct. 23, 2008

(54) Orthotics and prosthetics for shodding a horse and methods of fabrication and measurement therefor

(76) Inventor: Brent E. Huskey, Tomball, TX (US)

Correspondence Address: Raymond R. Ferrera;Adams and Reese, LLP, Suite 4400, 1221 McKinney Street, Houston, TX, 77010, US

(21) Appl. No.: 12/012,580

(22) Filed: Feb. 4, 2008

Related U.S. Application Data
(60) Provisional application No. 60/899,239, filed on Feb. 2, 2007.

(51) Int. Cl. A01L 11/00

(52) U.S. Cl. 168/45

(57) ABSTRACT

A method for shodding a horse with a variety of orthotic and prosthetic shoes is provided, which includes the use of a laser mounted on a vertically variable staging platform to measure the differences in length of a horse's legs. The laser-based measurements are then combined with observed hoof pitch dimensions in order to determine the height and angle of appropriate build-ups for a horseshoe, of which a mold is than made. A conventional horseshoe is placed in a shoe mold, and a polyurethane or other durable but initially pliable material is selectively poured so as to build up portions of the shoe. The build ups correct both the differences in leg length and variations and inconsistencies in the shape of the horse's hooves, thereby creating an appropriate orthotic or prosthetic shoe suitable for shodding.

The present invention relates to the farrier arts, and in a particular though non-limiting embodiment, to orthotics and prosthetics useful for shodding a horse, and methods of fabrication and measurement therefor.

It is common for equines to suffer from joint and muscle difficulties attributable to stress induced by legs of uneven length, and/or hooves of inconsistent dimension. For example, horses having back legs of uneven length commonly suffer from hip and back strain attributable to the fact that their weight load is borne unequally, and horses having hooves of inconsistent dimension commonly suffer from fetlock strain and other joint maladies attributable to the fundamentally unequal distribution of weight beneath the animal's center of gravity.

Certain prior art has attempted to alleviate the problem by forming builds of a sort out of polyurethane molded to fit beneath the bottom of the horse's hoof in place of a shoe, and in other known embodiments, as a padding placed into the heel-like void (sometimes called a frog) formed in the center-rear of the hoof. Such attempts have proven useful to a degree, but suffer from the fact that the molded polyurethane material inevitably breaks down faster than would a conventional metal shoe, and also because the builds tend to be imprecisely fabricated and shod.

It is therefore contemplated herein to resolve the problem in a more permanent and reliable manner, so that the horse is safely shod, and ensured of a reliable surface upon which weight can be evenly borne, thereby alleviating the aforementioned joint discomfiture.

In particular, the present invention relies on carefully prepared orthotic and prosthetic builds applied to the upper surfaces of conventional horseshoes, which are then shod in accord with typically known farrier practices.

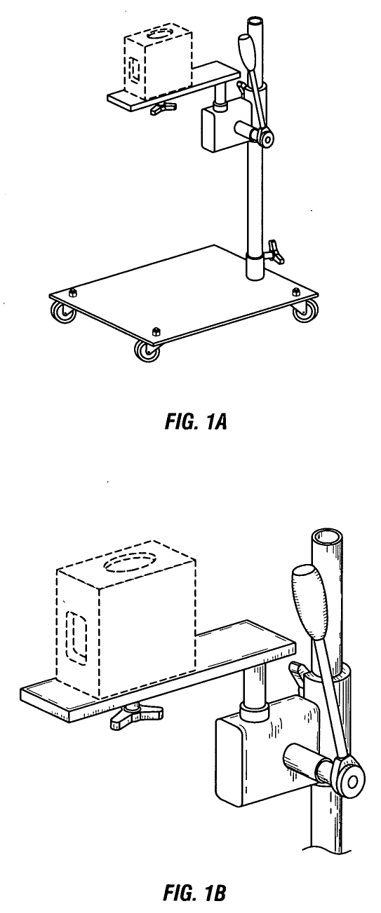

With reference to FIG. 1A, an apparatus is depicted that is useful for precisely measuring the differences in length of a horse's front and back legs, the apparatus comprising a leveling laser mounted on a stable, vertically variable staging platform (a closer view of which is depicted in FIG. 1B). It would of course be possible to use the leveling laser without a height variable platform, though the inventor has found to date that more precise measurements can be obtained if the laser is held at a fixed, known height as the measurements are being taken.

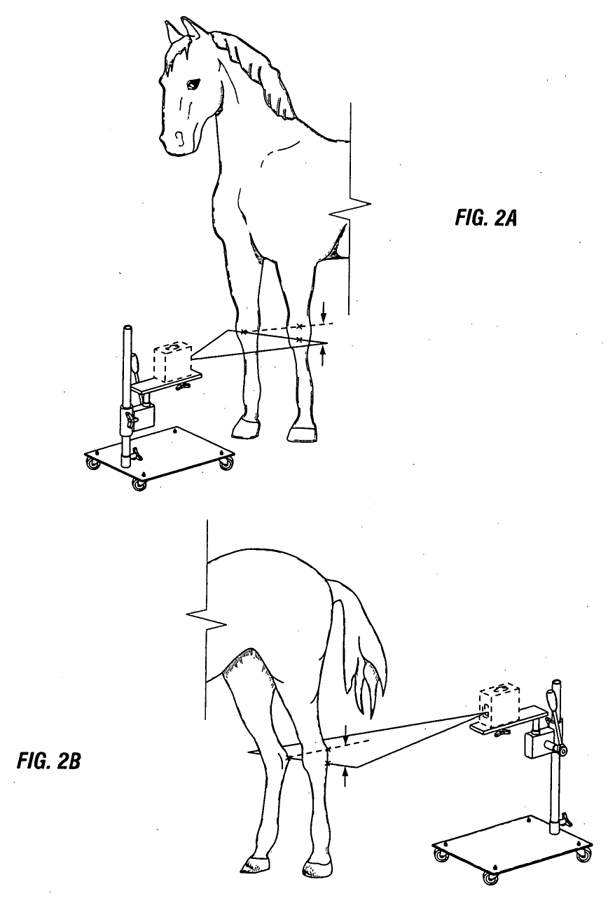

As depicted in FIG. 2A, the measuring technique essentially comprises the shooting of a thin, fanned laser beam across the knee area, with particular attention being paid to the targeting of the laser at a set point on one of the animal's legs, for example, the knee of one of the front legs. To measure the difference in length between legs, an operator has two options. In one embodiment, the laser's light is shone across both legs simultaneously, so that the desired knee bone or other set point is directly in the path of the light. The point at which the light hits the other leg can then be marked, and the difference between the set point on the first leg and the offset point on the second can be measured and recorded, as suggested in the drawing.

Alternatively, the measurements can be computed from the point at which the laser strikes the legs from the impact points down to the ground. In this embodiment, the legs can be measured either simultaneously or individually. Either way, any difference in the lengths of the legs from the measured points downward or therebetween is established to such a near certainty that the height of the orthotic or prosthetic required for build-up can be reliably ascertained.

As seen in FIG. 2B, the device can also be employed for measuring differences in length of the horse's rear legs, only this time, the predetermined set point will generally be in the area of the horse's hocks, though other set points will naturally suffice as well. Again, the ultimate height of the build-up can be determined by measuring either the difference between the set point and the offset point while illuminated by the laser, or instead by measuring from the light impact point down to the ground with respect to each leg.

In alternative embodiments of the invention, a hoof gauge or the like is then used to determine the extent of taper associated with the heel of the hoof, or in further embodiments, the extent of taper associated with the periople (the front-most, toe-like part of the hoof), the side wall (which surrounds the sides of the hoof), and the bulb (located near the back of the hoof). Once the desired dimensions of the hoof are gauged and recorded, the farrier is ready to combine such information together with the leg length differentials determined in the first stage of the process in order to form an appropriate build-up for the horseshoe.

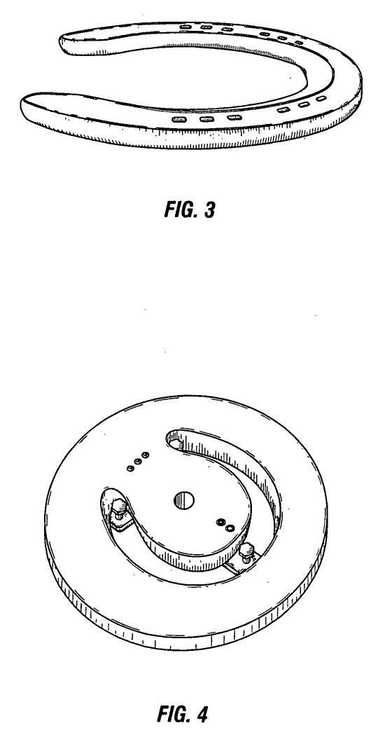

As seen in FIG. 3, a conventional horseshoe is flat on both its upper and lower surfaces, in no manner accounts for the different lengths and shapes discussed above. However, by placing the shoe in a mold (see FIG. 4) and covering various portions of the shoe with a polyurethane or other durable but initially pliable material, a build-up can be achieved which, upon setting, will account for both the differences in leg length and variations and inconsistencies in the shape of the horse's hooves. Since the effective walking surfaces of the hooves will thereafter be normalized with respect to the known defects, a more permanent and comfortable solution to the stress disorders mentioned above is achieved.

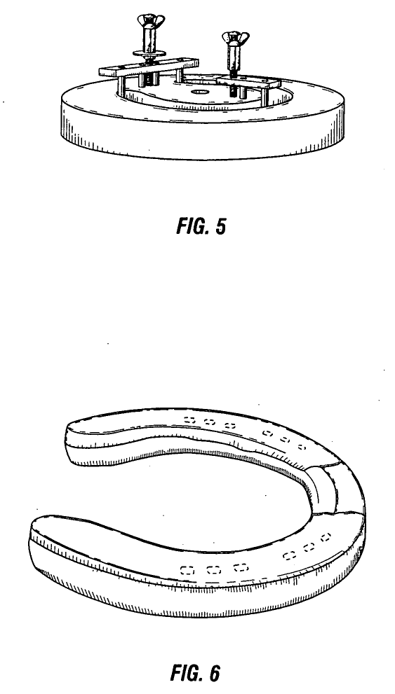

As seen in FIG. 5, after the polyurethane is poured in a fluid form into the mold and upon the shoe's upper surface, a variety of known brackets and clamps (See FIG. 5) can be used to press shims or other load transferring modules against the polyurethane, thereby ensuring that a smooth and well-compressed build-up is formed after the casts sets and hardens.

While the inventor has found that use of polyurethane is presently the best mode of achieving a build up for the shoe, those of ordinary skill in the pertinent arts will appreciate that other substances and compounds can be substituted without departing from the invention, so long as the material is initially deformable, and then capable of a permanent reformation into an appropriate orthotic or prosthetic form.

As seen in FIG. 6, depending on the precise defects or irregularities in the shape of the hoof and the length of the legs, it is quite possible that the build-up will predominantly slope either upwardly or downwardly as the build-up traverses the length of the shoe. The depiction of FIG. 6 is not intended to show the only possible result, however, and those of skill in the art will readily appreciate that various sections of the shoe may be coated and pressed with polyurethanes of different hardness and thickness, and also at various angles of inclination and declination, as is necessary to ensure a sure and reliable fit that adjusts for the differences in the length of the horse's legs and the shapes of the hooves that inevitably occur in such creatures.

The foregoing specification is provided for illustrative purposes only, and is not intended to describe all possible aspects of the present invention. Moreover, while the invention has been shown and described in detail with respect to several exemplary embodiments, those of ordinary skill in the pertinent arts will appreciate that minor changes to the description, and various other modifications, omissions and additions may also be made without departing from either the spirit or scope thereof.

1. An apparatus for measuring differences in the lengths of a horse's legs, the apparatus comprising a leveling laser mounted on a stable, vertically variable staging platform.
